(19) United States
(12) Patent Application Publication
(10) Pub. No.: US 2018/0290184 A1
(43) Pub. Date: Oct. 11, 2018

(54) NOZZLE CLEANER DEVICE

(71) Applicant: SHINKOKIKI CO., LTD., Nagoya-Shi (JP)

(72) Inventors: Takeo Fukizawa, Nagoya-Shi (JP); Etsuo Masuoka, Miyoshi-Shi (JP); Hidehiro Ishii, Kasugai-Shi (JP)

(73) Assignee: SHINKOKIKI CO., LTD., Nagoya-Shi (JP)

(21) Appl. No.: 16/009,611

(22) Filed: Jun. 15, 2018

Related U.S. Application Data
(63) Continuation of application No. PCT/JP2016/057755, filed on Mar. 11, 2016.

(51) Int. Cl. B08B 9/02; B08B 9/04; B23K 9/32

(52) U.S. Cl. CPC B08B 9/021; B08B 1/005; B23K 9/328; B08B 9/04

(57) ABSTRACT

A nozzle cleaner device attached to a tip end of a nozzle used in arc welding is provided. The nozzle cleaner device is for removing spatter attached to a tip end of a nozzle of an electrode for arc welding, including a main body provided within an operation area of a robot arm which operates the electrode, the main body of the cleaner device includes a tub-shaped box body and a polishing part erected at a center part of the bottom surface of the box body; the polishing part is made of a material softer than a metal which constitutes the nozzle, and formed in a cylinder shape that can be inserted into the nozzle; and the nozzle onto which spatter is attached is carried to the main body of the cleaner device to remove the spatter by means of the polishing part inserted into the nozzle.

### TECHNICAL FIELD

The present invention relates to a nozzle cleaner device which can easily remove spatter attached to a tip end of a nozzle used in arc welding.

### BACKGROUND ART

Conventionally, arc welding has widely been utilized as a means for spot-coupling various parts such as automobile parts. As electrodes used in this arc welding, those in which a cylindrical nozzle covers the periphery of a contact tip mounted at a tip end of a tip holder are commonly used. When this arc welding is continuously performed, attachments such as welding waste and dust, called spatter, are deposited within the nozzle, and this spatter is likely to prevent accurate welding process. So, it is necessary to periodically detach and clean the nozzle, to periodically spray compressed air onto the nozzle to blow the spatter off, or to replace the nozzle with a new one.

However, a method including detaching the nozzle, for example, from a robot arm, thereafter further disassembling the nozzle and the contact tip and manually brushing the nozzle is commonly used to clean the nozzle, and involves the problem of being troublesome and requiring a long time. When spatter is blown off with compressed air, complete removal thereof is difficult, and the spatter disadvantageously contaminates an environment. Further, no troublesome cleaning process would be necessary if the nozzle is replaced with a new one, but there are caused the problems that the cost is increased, and, additionally, that the quantity of garbage to be discarded is also increased, leading to wasteful consumption of resources.

As a nozzle cleaner device, there have conventionally been proposed various devices as presented, for example, in Patent Literatures 1 and 2. However, the device descried in Patent Literature 1 is a device which uses a dedicated cutter to shave spatter off, has a complex structure, and disadvantageously requires periodical replacement of the cutter and therefore troublesome maintenance. The device described in Patent Literature 2, which has previously been proposed by the present applicant, is a device which uses a coil spring to shave spatter off, and disadvantageously causes shaving unevenness in some cases and requires a complicated coil spring replacement operation.

### CITATION LIST

### Patent Literatures

Patent Literature 1: JP 2005-270999 A

Patent Literature 2: JP 3877201 B

### SUMMARY OF INVENTION

### Technical Problem

An object of the present invention is to solve the conventional problems presented above to provide a nozzle cleaner device which can easily remove an attachment deposited within a nozzle by arc welding, without detaching the nozzle from a robot arm and, besides, in an assembled state without disassembling the electrode into parts.

### Solution to Problem

The nozzle cleaner device of the present invention which has been made to solve the problems is a nozzle cleaner device for removing spatter attached to a tip end of a nozzle of an electrode for arc welding, including a main body, wherein
the main body of the cleaner device is provided within an operation area of a robot arm which operates the electrode, and has a structure capable of freely carrying the nozzle mounted at a tip end of the robot arm to the main body of the cleaner device;
the main body of the cleaner device includes a tub-shaped box body and a polishing part erected at a center part of the bottom surface of the box body;
the polishing part is made of a material softer than a metal which constitutes the nozzle, and formed in a cylinder shape that can be inserted into the nozzle; and
the nozzle onto which spatter is attached is carried to the main body of the cleaner device to remove the spatter by means of the polishing part inserted into the nozzle.

According to a preferred embodiment, it is preferred that either one of the polishing part and the nozzle should be coupled to a driving motor so as to freely rotate around an axial direction.

According to another preferred embodiment, it is preferred that a cutting part for spatter removal should be formed on an outer surface of the polishing part.

### Advantageous Effects of Invention

In the nozzle cleaner device of the present invention, the main body of the cleaner device is provided within an operation area of a robot arm which operates the electrode, and has a structure capable of freely carrying the nozzle mounted at a tip end of the robot arm to the main body of the cleaner device. The main body of the cleaner device also includes a tub-shaped box body and a polishing part erected at a center part of the bottom surface of the box body, and the polishing part is made of a material softer than a metal which constitutes the nozzle and formed in a cylinder shape that can be inserted into the nozzle. Further, the nozzle onto which spatter is attached is carried to the main body of the cleaner device to remove the spatter by means of the polishing part inserted into the nozzle. So, when an attachment is deposited within the nozzle, the robot arm can be moved toward the main body of the cleaner device to easily conduct removal process of the spatter. Besides, the removal process can be easily and surely conducted in a state where the electrode remains assembled without disassembling the electrode into parts.

When either one of the polishing part and the nozzle is coupled to a driving motor so as to freely rotate around an axial direction, the polishing part can be operated not only in the longitudinal direction, but also in the circumferential direction, of the nozzle to more surely remove the spatter attached to the inner circumferential surface.

When a cutting part for spatter removal is formed on an outer surface of the polishing part, it is made possible to efficiently cut the spatter by means of the cutting part and surely remove the spatter.

### BRIEF DESCRIPTION OF DRAWINGS

FIG. 1 is a front view showing an embodiment of the present invention.

FIG. 2 is a cutout front view showing a main body of a cleaner device.

FIG. 3 is a plan view of FIG. 2.

FIG. 4 is a cutout side view showing a main body of another cleaner device.

FIG. 5 is a cutout front view of FIG. 4.

FIG. 6 is a perspective view showing a polishing part.

FIG. 7 is a perspective view showing another polishing part.

FIG. 8 is an explanatory view showing an essential part of the polishing part.

FIG. 9 is an explanatory view showing a state where the polishing part is inserted into a nozzle.

### DESCRIPTION OF EMBODIMENTS

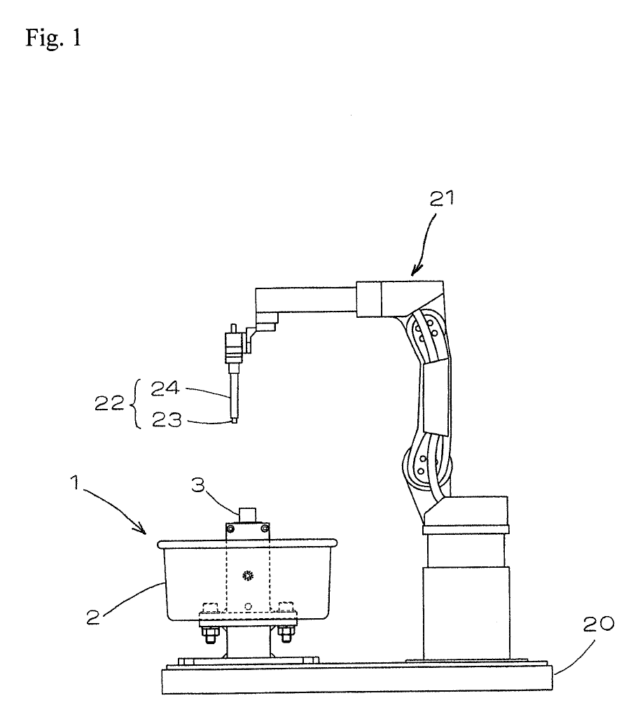

Hereinafter, preferred embodiments of the present invention will be illustrated with reference to the drawings.
FIG. 1 is a front view of a nozzle cleaner device according to the present invention. In this figure, reference sign 20 indicates a base stand; 21 indicates a robot arm for welding; and 22 indicates an electrode for arc welding, which is mounted at a tip end of the robot arm 21. This electrode 22 is composed of a contact tip 23 and a cylindrical nozzle 24 surrounding the contact tip 23. The robot arm 21 is configured so as to be freely bent and rotated to move the electrode 22 at the tip end to a predetermined position and to thereby conduct a welding process of a work which is a substance to be welded (not shown).

In the operation area of the robot arm 21, a main body 1 of the cleaner device is provided separately from the work station for conducting welding, and has a structure capable of freely carrying the nozzle 24 mounted at a tip end of the robot arm 21 to the main body 1 of the cleaner device. Hence, the nozzle cleaner device is configured so as to carry the nozzle 24 to the main body 1 of the cleaner device to thereby make it possible to remove the spatter deposited within the nozzle 24 at an arbitrary timing or periodically.

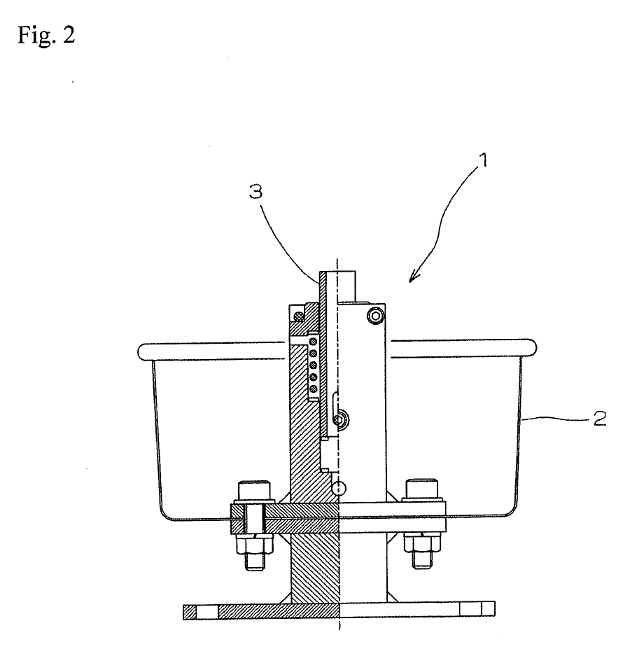

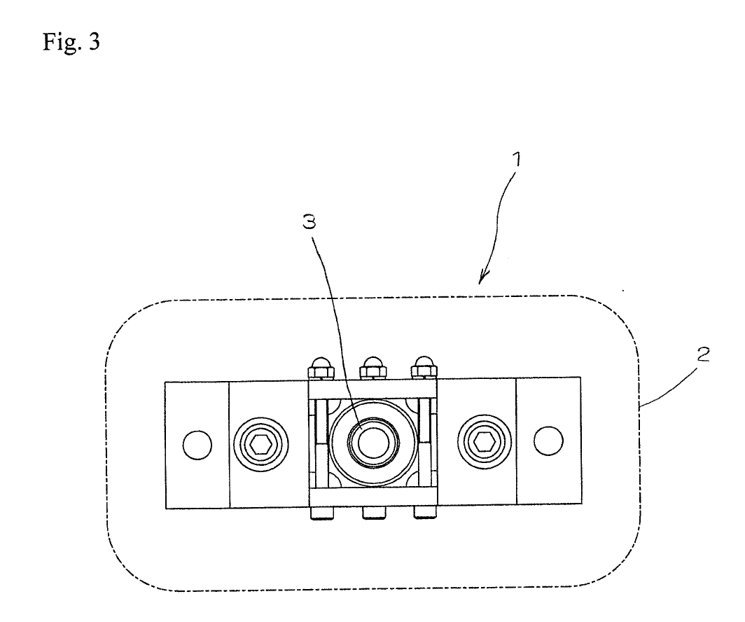

The main body 1 of the cleaner device has a square tub-shaped box body 2 opened at an upper part thereof and a polishing part 3 erected at a center part of the bottom surface of the box body 2, as shown in FIGS. 2 and 3. The box body 2 is intended to prevent the spatter from scattering to contaminate an environment, and is made of a metal or a synthetic resin. The outer diameter size and height of this box body 2 can be arbitrarily designed according, for example, to a free space inside the base stand 20. The polishing part 3 is intended to remove the spatter deposited within the nozzle 24, and is made of a relatively soft metal such as aluminum or a synthetic resin.

The polishing part 3 is formed in a cylinder shape that can be inserted into the nozzle 24, and inserted into the nozzle 24 onto which the spatter is deposited to be subjected to removal process of the spatter.
The spatter is welding waste and dust which scatter at the time of welding process to be attached and deposited onto a tip end of the inner circumferential surface of the nozzle 24, is hard and firmly attached, and thus must normally be shaved off with a cutter blade or the like. However, the present invention employs the nozzle 24 having an inner circumferential surface to which a super-extreme pressure lubricant that is chlorine-free and has achieved super-extreme pressure performance and a low friction coefficient is applied and on which a very-thin chemical coating film molecularly bonded to a metal surface is formed. Thus, the chemical coating film is formed on the inner circumferential surface of the nozzle 24 and retains smooth lubricity even under severe conditions such as high load, high loading, and high temperature and high humidity. The spatter generated at the time of welding process is merely attached onto the chemical coating film lightly and is not firmly fixed onto the metal surface of the nozzle 24. As a result of this, the spatter attached onto the chemical coating film can be easily wiped off by the polishing part 3 made of a soft material such as aluminum or a synthetic resin.

Thus, in the present invention, the polishing part 3 is made of a material softer than the metal which constitutes the nozzle 24, taking advantage of the property that the chemical coating film is formed on the inner circumferential surface of the nozzle 24. Specifically, the polishing part 3 can be formed of an aluminum material or a synthetic resin material such as heat-resistant polyethylene, polypropylene or polycarbonate. The polishing part 3 is formed in a cylinder shape that can be inserted into the nozzle 24 and configured to wipe off the spatter attached to the inner surface of the nozzle through sliding of the polishing part 3. As a result of this, the inner surface of the nozzle would not be damaged by the polishing part 3 during the removal of the spatter.

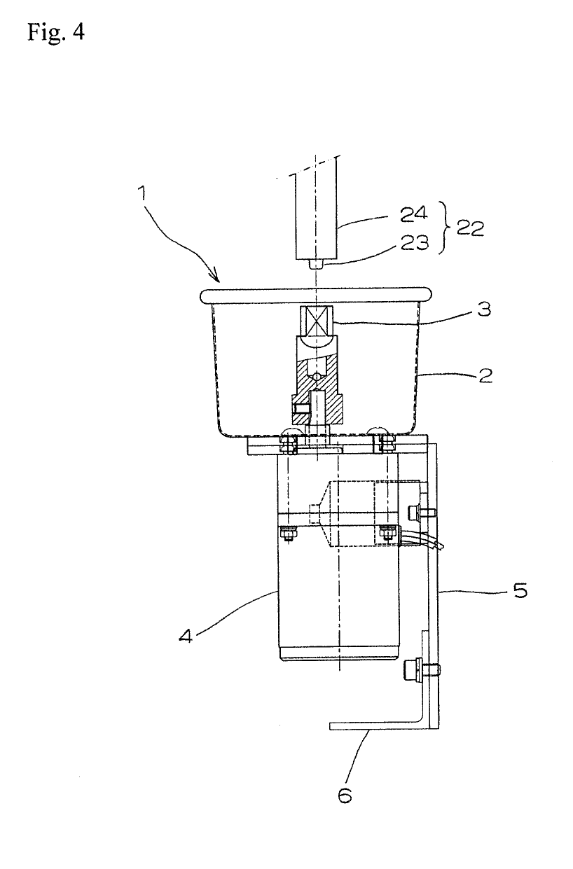

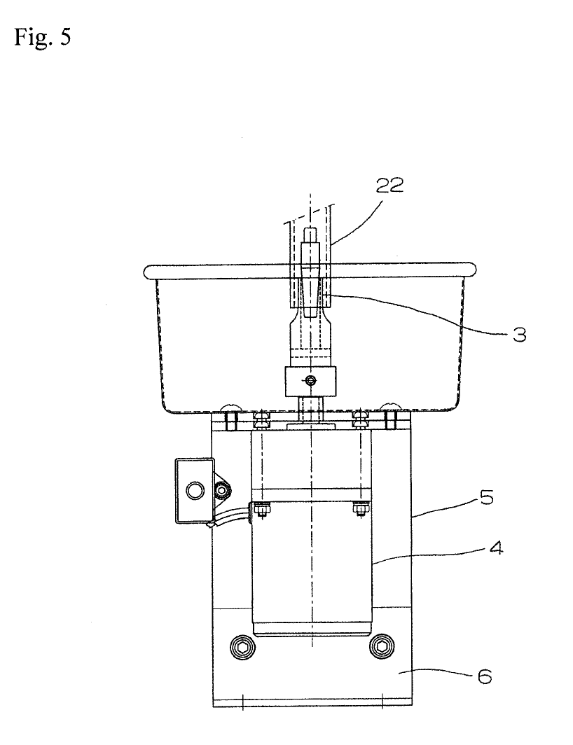

Also, the polishing part 3 can be configured to be coupled to a driving motor 4 so as to freely rotate around the axial direction of the cylinder, as shown in FIGS. 4 and 5. Thus, the polishing part 3 can be smoothly rotated to scrape off the spatter attached to the inner surface of the nozzle 24 more surely. The driving motor can be coupled not only to the polishing part 3 but also to the nozzle 24, and either one of the polishing part 3 and the nozzle 24 has only to freely rotate.
In the figures, reference sign 5 indicates a motor mounting bracket, and 6 indicates a unit mounting bracket. The driving motor 4 is mounted on the base stand 20 via these brackets.

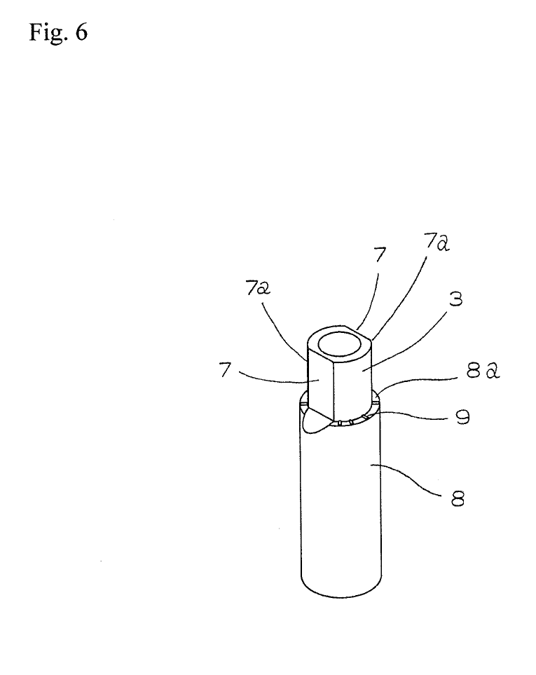

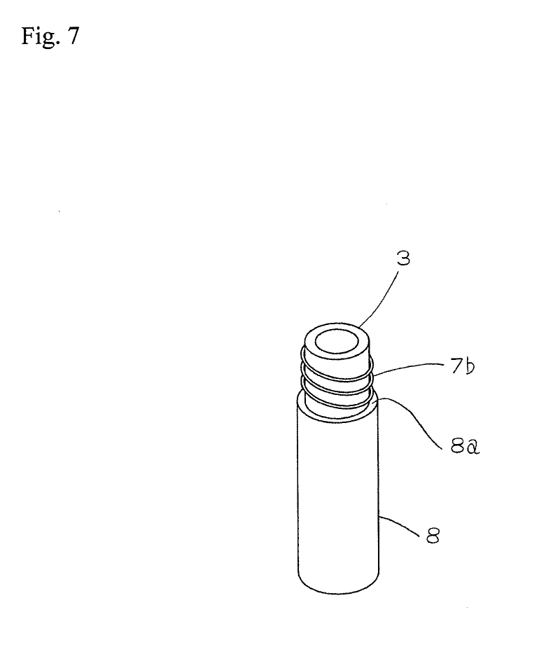

A cutting part 7 for spatter removal is formed on an outer surface of the polishing part 3. This cutting part 7 is intended to ensure more efficient removal of the spatter, and can be an edge 7a formed by chamfering the outer surface of the polishing part 3 in the axial direction, for example, as shown in FIG. 6. Alternatively, the cutting part 7 can be a projection 7b formed helically on the outer surface of the polishing part 3, as shown in FIG. 7. The edge 7a or projection 7b can be used to easily and surely remove the spatter attached to the inner circumferential surface of the nozzle 24.

Additionally, as shown in FIG. 6, the nozzle cleaner device can have a structure such that a pedestal part 8 having an outer diameter which is larger than that of the polishing part 3 is jointly provided with the base part of the polishing part 3, and that a protrusion 9 for cutting a tip end surface of the nozzle 24 is provided at a coupling step part 8a between the pedestal part 8 and the base part. The protrusions 9 can be uniformly or randomly provided on the coupling step part 8a and formed in an arbitrary shape. The protrusions 9 can be used to remove the spatter attached to the tip end surface of the nozzle 24 simultaneously.

Next, the case where the spatter attached to the tip end of the nozzle is removed by the nozzle cleaner device of the present invention will be described.
When a work which is a substance to be welded (not shown) is carried into the base stand 20, the robot arm 21 is bent and rotated to move to a predetermined position above the work for welding process. When spatter is thereafter deposited within the nozzle 24 due to repetition of this welding operation, the robot arm 21 is bent and rotated to move the nozzle 24 to the upper part of the main body 1 of the cleaner device (see FIG. 4).

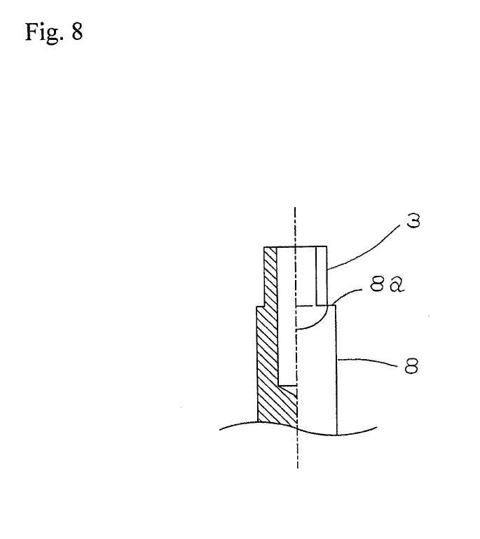

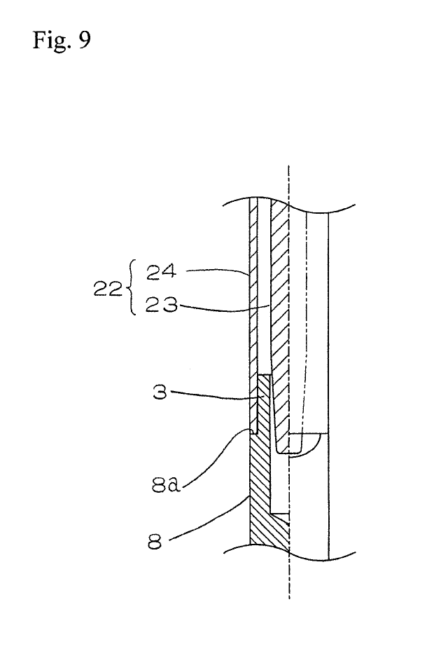

Then, the robot arm 21 is lowered to insert the polishing part 3 along the inside of the nozzle 24 (see FIG. 5). At this time, an electrode 23 is present in the nozzle 24, and there is a possibility that the electrode 23 may interfere with the polishing part 3. However, the polishing part 3 has a cylinder shape, and thus is introduced between the inner surface of the nozzle 24 and the electrode 23 when inserted into the nozzle 24, and would not interfere with the electrode 23 (see the explanatory views in FIGS. 8 and 9).

After insertion of the polishing part 3 until the tip end surface of the nozzle 24 abuts against the coupling step part 8a, the driving motor 4 is used to rotate the polishing part 3 or to move the nozzle 24 backward and forward in the axial direction to peel and remove the spatter attached to the inner surface of the nozzle 21. The spatter is merely attached lightly onto the chemical coating film formed on the outer surface of the nozzle 21, and thus would be easily peeled by the polishing part 3. Besides, the nozzle 21 would not be damaged by the polishing part 3.

Thereafter, it has only to operate the robot arm 21 to remove the polishing part 3 out of the nozzle 24. The robot arm 21 is bent and rotated again to move to the predetermined position above the work, and the welding process is continued. Since the peeled spatter is stored in the box body 2 and does not scatter, a clean environment can be maintained.

As is evident from the above description, in the present invention, the main body of the cleaner device is provided within an operation area of a robot arm which operates the electrode, and has a structure capable of freely carrying the nozzle mounted at a tip end of the robot arm to the main body of the cleaner device. The main body of the cleaner device also includes a tub-shaped box body and a polishing part erected at a center part of the bottom surface of the box body, and the polishing part is made of a material softer than a metal which constitutes the nozzle and formed in a cylinder shape that can be inserted into the nozzle. Further, the nozzle onto which spatter is attached is carried to the main body of the cleaner device to remove the spatter by means of the polishing part inserted into the nozzle. So, it is possible to move the robot arm toward the main body of the cleaner device to easily remove the spatter, when an attachment is deposited within the nozzle. Besides, the removal process can be easily and surely conducted in a state where the electrode remains assembled without disassembling the electrode into parts. Besides, only spatter can be removed without damaging the nozzle.

### REFERENCE SIGNS LIST

1. Main body of cleaner
2. Box body
3. Polishing part
4. Driving motor
5. Motor mounting bracket
6. Unit mounting bracket
7. Cutting part
7a. Edge
7b. Projection
8. Pedestal part
8a. Coupling step part
9. Protrusion
20. Base station
21. Robot arm
22. Electrode
23. Contact tip
24. Nozzle

1. A nozzle cleaner device for removing spatter attached to a tip end of a nozzle of an electrode for arc welding, comprising a main body, wherein
the main body of the cleaner device is provided within an operation area of a robot arm which operates the electrode, and has a structure capable of freely carrying the nozzle mounted at a tip end of the robot arm to the main body of the cleaner device;
the main body of the cleaner device includes a tub-shaped box body and a polishing part erected at a center part of the bottom surface of the box body;
the polishing part is made of a material softer than a metal which constitutes the nozzle, and formed in a cylinder shape that can be inserted into the nozzle; and
the nozzle onto which spatter is attached is carried to the main body of the cleaner device to remove the spatter by means of the polishing part inserted into the nozzle.

2. The nozzle cleaner device according to claim 1, wherein either one of the polishing part and the nozzle is coupled to a driving motor so as to freely rotate around an axial direction.

3. The nozzle cleaner device according to claim 1, wherein a cutting part for spatter removal is formed on an outer surface of the polishing part.

4. The nozzle cleaner device according to claim 2, wherein a cutting part for spatter removal is formed on an outer surface of the polishing part.
